(19) United States
(12) Patent Application Publication
(10) Pub. No.: US 2008/0146399 A1
(43) Pub. Date: Jun. 19, 2008

(54) Continuously Variable Ratio Transmission

(75) Inventors: Robert Andrew Oliver, Preston (GB); Alan Fielding, Lancashire (GB)

Correspondence Address: BROOKS KUSHMAN P.C., 1000 TOWN CENTER, TWENTY-SECOND FLOOR, SOUTHFIELD, MI, 48075, US

(73) Assignee: TOROTRAK (DEVELOPMENT) LIMITED, Leyland (GB)

(21) Appl. No.: 10/595,746

(22) PCT Filed: Nov. 10, 2004
(86) PCT No.: PCT/GB04/04736

§ 371 Date: Nov. 7, 2007

(30) Foreign Application Priority Data
Nov. 10, 2003 (GB) 0326199.7

(51) Int. Cl. F16H 37/08; F16H 37/10

(52) U.S. Cl. 475/216

(57) ABSTRACT

A continuously variable ratio transmission (CVT) comprises a ratio varying unit (“variator”), a first epicyclic (18) having two inputs (A2, S2) connected to opposite sides of the variator (V), a second. epicyclic (16) having an input (C1) driven by a prime mover (12) and components (A1, S1) connected to opposite sides of the variator, a final drive shaft (14), a low regime clutch (L) for selectively connecting the output of the first epicyclic to the final drive shaft in low regime and a third, mixing, epicyclic (20) connected to the output (C2) of the first epicyclic (18) and connected or connectable (F, R) to the variator and being connectible with the final drive shaft in high regime by way of a high regime clutch (F). The high and low regimes are coincident at least one variator ratio (or, more preferably, the operation ranges overlap) and the variator operates in opposite directions in the low and high regimes.

The present invention relates to continuously variable ratio transmissions (“CVTs”). The invention is particularly applicable to such transmissions for industrial or agricultural vehicles, for example tractors, which require a very high torque at low speeds and which often require the vehicle to be shuttled back and forth at low speeds, but which also have the requirement for high forward and high reverse regimes for higher speed, lower torque conditions.

In accordance with a first aspect of the present invention, there is provided a continuously variable ratio transmission (CVT) comprising:

(a) a ratio varying unit (“variator”);
(b) a first epicyclic having two inputs connected to opposite sides of the variator:
(c) a second epicyclic having an input driven by a prime mover and components connected to opposite sides of the variator:
(d) a final drive shaft;
(e) a low regime clutch for selectively connecting the output of the first epicyclic to the final drive shaft in low regime;
(f) a third, mixing, epicyclic connected to the output of the first epicyclic and connected or connectable to the variator and being connectible with the final drive shaft in high regime by way of a high regime clutch;
wherein the high and low regimes are coincident at least one variator ratio and the variator operates in opposite directions in the low and high regimes.

Preferably, the operation ranges of the high and low regimes overlap.

In accordance with a second aspect of the present invention there is provided a continuously variable ratio transmission (CVT) comprising:

(a) a ratio varying unit (“variator”);
(b) a first epicyclic having two inputs connected to opposite sides of the variator:
(c) a second epicyclic having an input driven by a prime mover and components connected to opposite sides of the variator:
(d) a final drive shaft connectible with the variator by way of one of two alternative driven rotatable members connected to opposite sides of the variator respectively; and
(e) a first clutch disposed between an output of the first epicyclic and the final drive shaft for selectively connecting the output of the first epicyclic to the final drive shaft:
the transmission further comprising:
a third, mixing, epicyclic disposed between at least one of the driven rotatable members and the final drive shaft and receiving inputs from the output of the first epicyclic and said driven rotatable shaft; and
a second clutch disposed between said one driven rotatable member and the final drive shaft for selectively connecting the said one driven rotatable member to the final drive shaft via the third epicyclic.

In one embodiment a third clutch is disposed between said other driven rotatable member and the final drive shaft for selectively connecting the said other driven rotatable member to the final drive shaft via the third epicyclic.

The second and third clutches are preferably disposed respectively between the said one driven rotatable member and the third epicyclic and between the said other driven rotatable member and the third epicyclic.

In another embodiment, a fourth epicyclic is disposed between said other driven rotatable member and the final drive shaft and receiving inputs from the output of the first epicyclic and said other driven rotatable shaft and a third clutch is disposed between said other driven rotatable member and the final drive shaft for selectively connecting the said other driven rotatable member to the final drive shaft via the fourth epicyclic.

The second and third clutches are preferably disposed respectively between the third epicyclic and the final drive shaft and the fourth epicyclic and the final drive shaft.

By way of example only, specific embodiments of the present invention will now be described, with reference to the accompanying drawings, in which:—

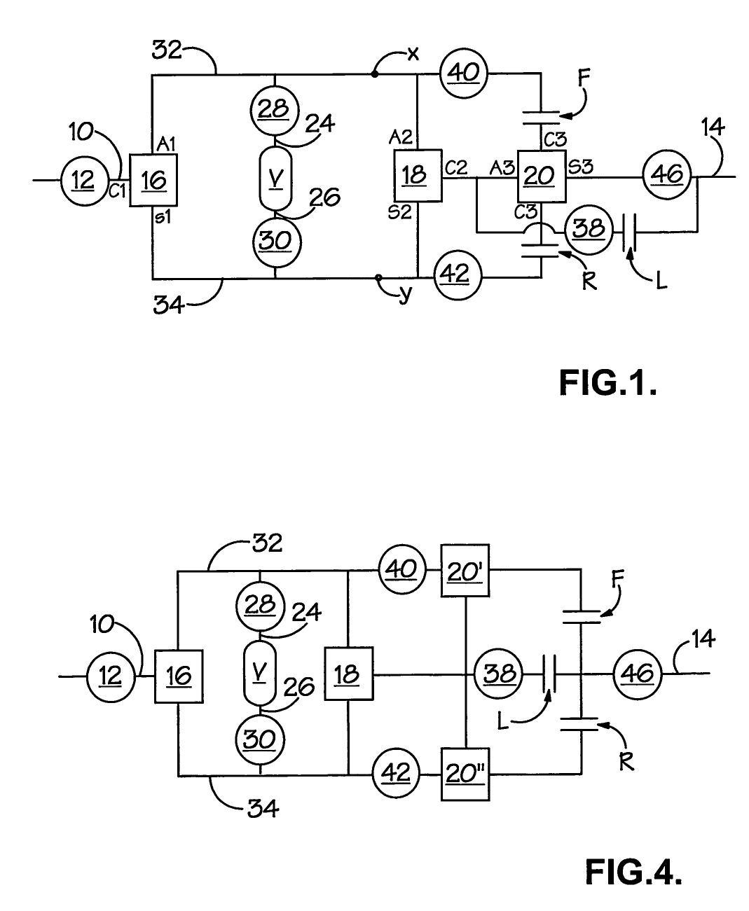

FIG. 1 is a diagrammatic representation of a first embodiment of CVT in accordance with the present invention;

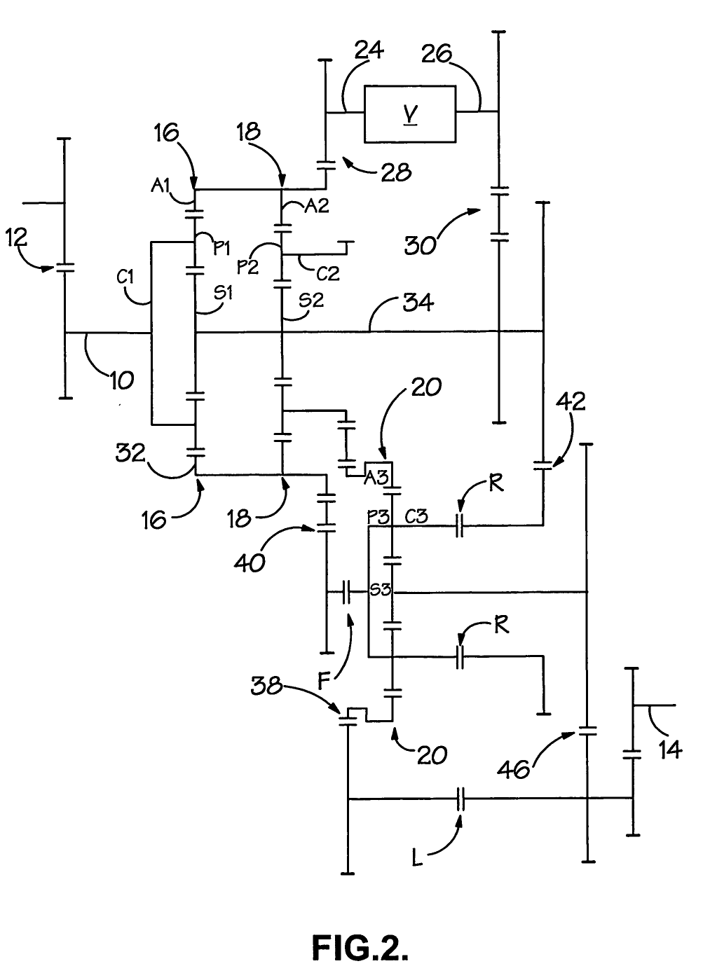

FIG. 2 is a representation of the transmission of FIG. 1, which illustrates the transmission gearing in more detail;

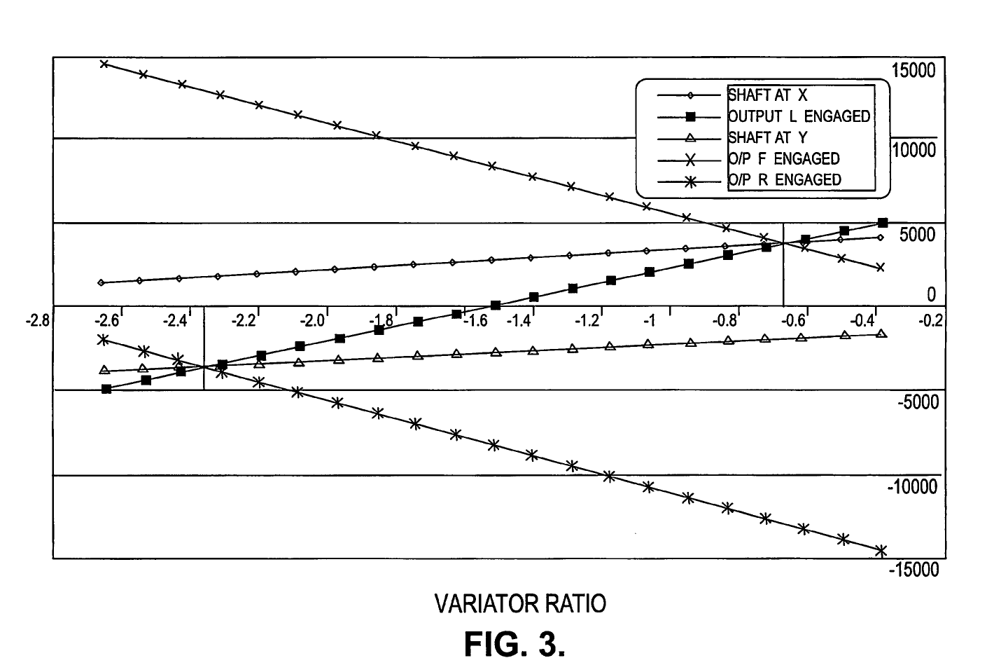

FIG. 3 is a graph illustrating the operation of the first embodiment: and

FIG. 4 is a diagrammatic representation of a second embodiment of CVT in accordance with the present invention.

Referring to FIGS. 1 and 2, a CVT has an input shaft 10, connected to a prime mover via reduction gearing 12, an output shaft 14, a variator V of the toroidal-race rolling traction type, an input epicyclic 16, a recirculating epicyclic 18 and a mixing epicyclic 20. Reference numerals 24,26 indicate shafts connected to opposite sides of the variator V, which are connected via reduction gearing 28,30 to rotating members (hereinafter referred to as “shafts”, for convenience) 32,34 which are in turn connected to two components (the annulus A1 and the sun gear S1 respectively) of the input epicyclic 16, the remaining component (the planet carrier C1) being connected to the input shaft 10.

The shafts 32,34 are also connected to two components (the annulus A2 and the sun gear S2) of the recirculating epicyclic 18, the third component (the planet carrier C2) being connected by engagement of a low regime clutch L and via reduction gearing 38 to the output shaft 14.

In addition, the shafts 32,34 are selectively and alternatively connectible via respective reduction gearing 40,42 and respective high regime forward and reverse clutches F,R to the same component (the planet carrier C3) of the mixing epicyclic 20, another component (the annulus A3) of the epicyclic being permanently connected to the output (the planet carrier C2) of the recirculating epicyclic 18. In low regime, the low regime clutch L is engaged and the high regime forward and reverse clutches F,R are disengaged. In low regime, power recirculates through the epicyclic 18 and, as shown in FIG. 3 by the line “Output L engaged”, as the variator V progresses from one end of its ratio range to the other the speed of the output shaft 14 can be arranged to make a continuous “low regime” progression from a finite maximum value in one direction, falling to zero and then climbing to a second maximum value in the opposite direction. In this way, the transmission can shuttle easily between reverse and forward without having to change regime. This is important for off-highway vehicles such as tractors and the like in which the transmission transmits high levels of torque at low vehicle speeds, during which it is preferable to avoid regime changes if possible.

It will also be seen from FIG. 3 that for each of a particular forward and reverse speed of the output shaft 14 there is a variator ratio (approximately −0.68 and −2.74, corresponding to an output shaft speed of about 4,000 rpm) at which the output from the mixing epicyclic 20, if it were to be connected by the respective high regime forward or reverse clutch F,R, would be identical to the output from the mixing epicyclic 18 on engagement of the low regime clutch L, i.e. the two inputs to the mixing epicyclic 20 would be identical. This is known as “synchronous ratio” and at that ratio the forward or reverse clutch F,R can be engaged, depending on the direction of rotation of the output shaft 14, and the low regime clutch L can be disengaged in order to place the transmission in a high forward or high reverse regime as appropriate.

In high forward or high reverse regime, as illustrated in FIG. 3, the variator ratio is adjusted in the opposite direction as compared with low regime operation in order to increase the speed of the output shaft 14. In these regimes, the drive of one of the shafts 32, 34 is connected to the output shaft 14 via the engaged clutch F or R, the mixing epicyclic 20 (through the output component, sun gear S3) and reduction gearing 46.

A second embodiment is illustrated in FIG. 4. This is very similar to the first embodiment and the same reference numerals are used to describe corresponding features. The main difference is that the single mixing epicyclic 20 of the first embodiment is replaced with two mixing epicyclics 20′, 20″, a component (the planet carrier) of each of which is connected to a respective one of the two shafts 32,34, a further component (the sun gear) of each of the epicyclics 20′, 20″ being selectively and alternatively connectible to the output shaft 14 via forward and reverse high regime clutches F,R respectively. In a similar manner to the first embodiment, the output of the recirculating epicyclic 18 is connected to a component (the annulus) of each of the forward and reverse mixing epicyclics 20′, 20″ and is also connectible via a low regime clutch L to the output shaft 14. When high forward or high reverse regime is required at synchronous ratio, the appropriate forward or reverse clutch F,R is engaged and the low regime clutch L is disengaged to connect the output of the appropriate mixing epicyclic 20′, 20″ to the output shaft 14 via the reduction gearing.

The invention is not restricted to the details of the foregoing embodiments.

1. A continuously variable ratio transmission (CVT) comprising:
(a) a ratio varying unit (“variator”);
(b) a first epicyclic having two inputs connected to opposite sides of the variator:
(c) a second epicyclic having an input driven by a prime mover and components connected to opposite sides of the variator:
(d) a final drive shaft;
(e) a low regime clutch for selectively connecting the output of the first epicyclic to the final drive shaft in low regime;
(f) a third, mixing, epicyclic connected to the output of the first epicyclic and connected or connectable to the variator and being connectible with the final drive shaft in high regime by way of a high regime clutch;
wherein the high and low regimes are coincident at least one variator ratio and the variator operates in opposite directions in the low and high regimes.

2. A continuously variable ratio transmission (CVT) as claimed in claim 1, wherein the operation ranges of the high and low regimes overlap.

3. A continuously variable ratio transmission (CVT) comprising:
(a) a ratio varying unit (“variator”);
(b) a first epicyclic having two inputs connected to opposite sides of the variator:
(c) a second epicyclic having an input driven by a prime mover and components connected to opposite sides of the variator:
(d) a final drive shaft connectible with the variator by way of one of two alternative driven rotatable members connected to opposite sides of the variator respectively; and
a first clutch disposed between an output of the first epicyclic and the final drive shaft for selectively connecting the output of the first epicyclic to the final drive shaft:
the transmission further comprising:
a third, mixing, epicyclic disposed between at least one of the driven rotatable members and the final drive shaft and receiving inputs from the output of the first epicyclic and said driven rotatable shaft; and
a second clutch disposed between said one driven rotatable member and the final drive shaft for selectively connecting the said one driven rotatable member to the final drive shaft via the third epicyclic.

4. A CVT as claimed in claim 3, further comprising a third clutch disposed between said other driven rotatable member and the final drive shaft for selectively connecting the said other driven rotatable member to the final drive shaft via the third epicyclic.

5. A CVT as claimed in claim 4, wherein the second and third clutches are disposed respectively between the said one driven rotatable member and the third epicyclic and between the said other driven rotatable member and the third epicyclic.

6. A CVT as claimed in claim 3, further comprising:
a fourth epicyclic disposed between said other driven rotatable member and the final drive shaft and receiving inputs from the output of the first epicyclic and said other driven rotatable shaft; and
a third clutch disposed between said other driven rotatable member and the final drive shaft for selectively connecting the said other driven rotatable member to the final drive shaft via the fourth epicyclic.

7. A CVT as claimed in claim 6, wherein the second and third clutches are disposed respectively between the third epicyclic and the final drive shaft and the fourth epicyclic and the final drive shaft.
